(19) United States
(12) Patent Application Publication
(10) Pub. No.: US 2008/0295940 A1
(43) Pub. Date: Dec. 4, 2008

(54) INNER TUBE OF A TIRE

(76) Inventor: Tseng-Ping TIEN, Taichung Hsien (TW)

Correspondence Address: EGBERT LAW OFFICES, 412 MAIN STREET, 7TH FLOOR, HOUSTON, TX, 77002, US

(21) Appl. No.: 12/120,966

(22) Filed: May 15, 2008

(30) Foreign Application Priority Data
Jun. 4, 2007 (TW) 096119947

(51) Int. Cl. B60C 5/02

(52) U.S. Cl. 152/511

(57) ABSTRACT

The present invention is an environment-friendly inner tube The inner tube is formed by a constituent including a Thermoplastic Elastomer TPE that efficiently improves toughness and oxidation resistance. When the inner tube is penetrated by a sharp article, its gas retaining property postposes air leakage and stiffens the inner tube, thus prolonging service life of the tire. The inner tube is fabricated by an injection molding machine with improved productivity. Thermoplastic Elastomer will not produce toxic substances, and overflow and wastes generated from manufacturing process can be recycled, thus avoiding waste of resources, saving the materials and lowering manufacturing costs with better industrial efficiency.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an inner tube, and more particularly to an innovative inner tube with a new constituent.

2. Description of Related Art Including Information Disclosed Under 37 CFR 1.97 and 37 CFR 1.98.

The present invention is designed to improve the inner tubes of tires, including tires for motorcycles and bicycles, which are mainly made from natural or synthetic rubber. Natural rubber is a long-chain polymer of Isoprene. The long-chain polymer will become viscous in the event of high temperature or brittle in the event of low temperatures. The rubber will return to be elastic if mixed with sulfur into the raw compound with heat. This reaction occurs because sulfur atoms and long-chain molecules will cross-bond, so that the rubber resumes its original state after being released. The process of adding sulfur to result in cross-bonding is called vulcanization. The sulfur content in the rubber will affect its hardness, and a higher sulfur content means a greater rubber hardness.

However, rubber cannot be fully vulcanized. Remaining unvulcanized sulfur and rubber molecules will slowly cause bonding, so that the rubber will stiffen over time as the amount of vulcanization increases. Thus, it is learnt that the inner tube will gradually become brittle. Referring to FIG. 1, when the typical inner tube 10 made of vulcanized rubber is penetrated by a sharp article 11, such as a nail, the poor toughness of the penetrated portion of the inner tube 10 will lead to rapid leakage of air pressure P from the inner tube 10, making it impossible for the users to timely respond, although slow leakage of air pressure can be repaired.

As for the fabrication process of a typical inner tube, natural rubber is often molded through heating and vulcanization, during which gas is generated. So, air in the mold cavity shall be discharged to fill the raw materials. The mold shall be opened or closed intermittently but repetitively for air discharge and filling purposes. Hence, different absolute closing or opening modes of the mold of the injection molding machine will lead to slow and insufficient forming of a typical inner tube.

As for the vulcanized rubber of typical inner tube, the burning sulfur in the air will produce sulfur dioxide (SO₂), a component of dioxin, which is a colorless, toxic and stimulative gas and soluble in water to generate sulfite (H₂SO₃), acting as a main cause of acid rain. When the inner tube waste burns or the inner tube of a vehicle in a traffic accident burns, toxic air will be produced, resulting in serious pollution and harm to the environment.

Moreover, the overflow and wastes generated from manufacturing of inner tubes by vulcanized rubber cannot be recycled, leading to not only waste of resources, but also higher manufacturing costs.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

As the circular wall of the inner tube is fabricated by combining hydrogenated Thermoplastic Elastomer (SEBS) with the natural rubber of inner tube, a hydrorubber can be formed, thereby improving the toughness and oxidation resistance of inner tube 10. As such, when the inner tube 10 is penetrated by a sharp article 11, its gas retaining property postpones air leakage and stiffens the inner tube 10, thus prolonging service life of the tire.

The Thermoplastic Elastomer presents the feature of re-sulfurized rubber without need of adding sulfur, returning the inner tube to its original state after stretching. Moreover, the inner tube could be fabricated quickly by injection molding machine with improved productivity, providing a strength equivalent to or better than re-sulfurized rubber.

The Thermoplastic Elastomer will not produce toxic substances, such as dioxin, even in the process of combustion, thereby reducing environmental pollution and expanding sources of renewable resources for meeting the demands of environmental protection.

The overflow and wastes generated from manufacturing of Thermoplastic Elastomer can be recycled, thus avoiding waste of resources, saving materials and lowering down manufacturing costs with better industrial efficiency.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 depicts a cross-sectional view of conventional operation.

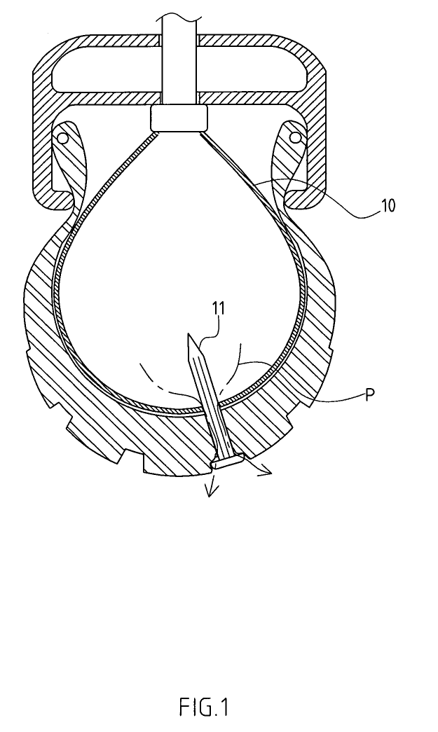

FIG. 2 depicts a partially enlarged perspective view of the preferred embodiment of the present invention.

FIG. 3 depicts a perspective view of the application of the preferred embodiment of the present invention.

FIG. 4 depicts a cross-sectional view and partially exploded sectional view of the preferred embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

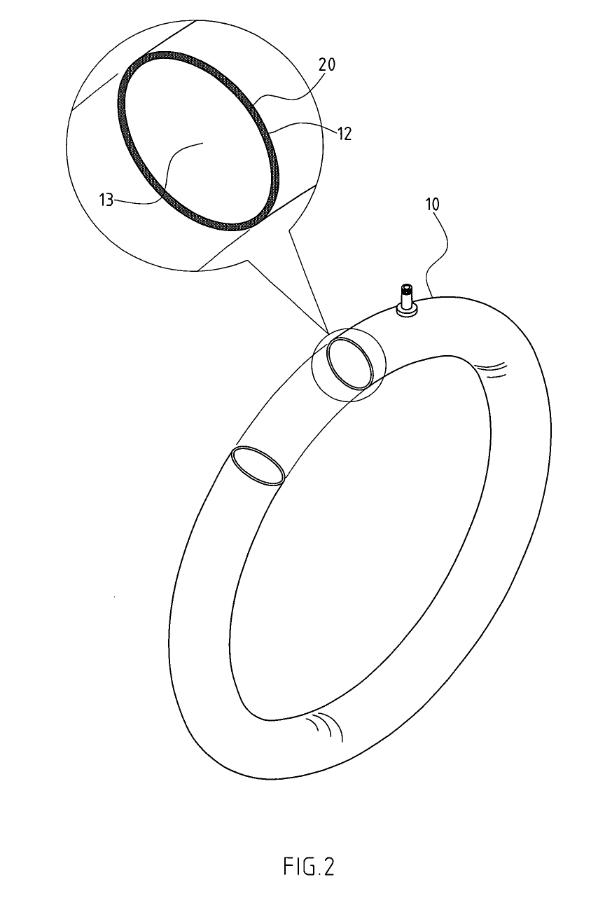

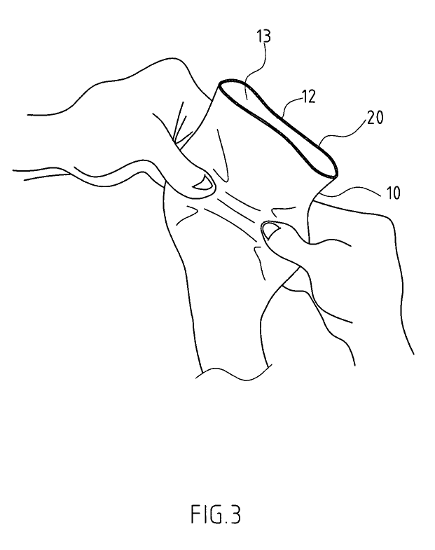

FIGS. 2-4 depict preferred embodiments of environmental-friendly inner tube of the present invention. The embodiments are provided only for explanatory purposes with respect to the patent claims.

The inner tube 10 is formed into an annular ring shape that defines a circular wall 12 and an air hold tank 13 within the circular wall 12. The circular wall 12 is made from said constituent 20.

Said constituent 20 is mainly composed of Thermoplastic Elastomers (TPE), such as: polystyrene (SBS, SIS, SEBS, SEPS), double-vinyl (TPB, TPI), trichloroethylene (TPVC, TCPE), urethane (TPU), esters (TPEE), amines (TPAE), organic fluoride (TPF), organic silicone, thermoplastic rubber (TPR) and silicone rubber.

Said constituent 20 is formed by SBS hydrogenation (styrene-butadiene-styrene copolymers) with cobalt and nickel catalysts.

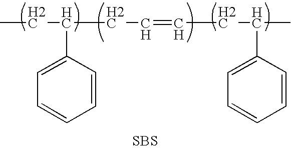

In the presence of C═C unsaturated double bonds in SBS copolymers, SBS copolymers will lack of weather resistance and thermal stability under sunlight, ultraviolet light and a high-temperature environment, thus limiting its broader application. Hydrogenation permits saturation of C═C double bonds in SBS intermediate polybutadiene soft section, making it become styrene-ethylene butylene-styrene copolymers(SEBS).

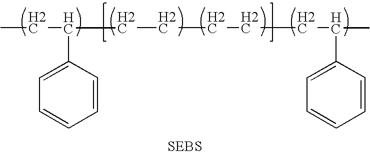

Original C═C bonds will reach a saturated state through hydrogenation, thus forming a hydrogenated Thermoplastic Elastomer SEBS; since hydrogen molecules are fairly stable, the H—H bond is not vulnerable to rupture. So, it can be used as an environmental-friendly hydrorubber of high polymerization and good gas retaining property.

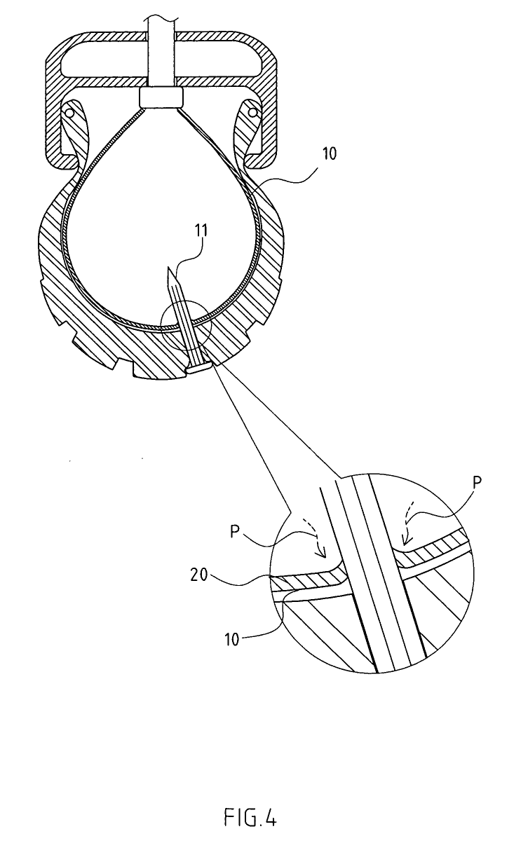

Referring to FIG. 4, when the inner tube 10 is penetrated by a sharp article 11, such as a nail, the constituent 20 contained by the hydrorubber of excellent polymerization wraps the edge of sharp article 11, thus protecting it against any damage or rupture, and avoiding air leakage from air hold tank.

1. An environment-friendly inner tube, wherein the said inner tube comprising:
an annular ring having a circular wall and an air hold tank within said circular wall, said circular wall being comprised of a constituent, said constituent being comprised of a Thermoplastic Elastomer (TPE).

2. The inner tube defined in claim 1, wherein said Thermoplastic Elastomer is hydrogenated.

3. The inner tube defined in claim 1, wherein said Thermoplastic Elastomer is comprised of polystyrene (SBS, SIS, SEBS, SEPS), double-vinyl (TPB, TPI), trichloroethylene (TPVC, TCPE), urethane (TPU), esters (TPEE), amines (TPAE), organic fluoride (TPF), organic silicone, thermoplastic rubber (TPR) and silicone rubber.
